(19) United States
(12) Patent Application Publication
(10) Pub. No.: US 2011/0028598 A1
(43) Pub. Date: Feb. 3, 2011

(54) Rubber Composition with very low Zinc Content

(75) Inventors: Anne Veyland, Marsat (FR); Jesé Carlos Araujo Da Silva, Pont du Chateau (FR)

Correspondence Address: COHEN, PONTANI, LIEBERMAN & PAVANE LLP, 551 FIFTH AVENUE, SUITE 1210, NEW YORK, NY, 10176, US

(73) Assignees: Societe De Technologie Michelin, Clermont-Ferrand (FR); Michelin Recherche et Technique S.A., Granges-Paccot (CH)

(21) Appl. No.: 12/809,777

(22) PCT Filed: Dec. 16, 2008
(86) PCT No.: PCT/EP08/67671

§ 371 Date: Sep. 21, 2010

(30) Foreign Application Priority Data
Dec. 21, 2007 (FR) 0760207

(51) Int. Cl. C08L 9/00

(52) U.S. Cl. 523/157; 524/571

(57) ABSTRACT

The invention relates to a rubber composition based on at least one diene elastomer, containing less than 0.5 phe of zinc, phe signifying parts per hundred parts of elastomer, and based on at least:
one reinforcing filler;
   one sulphur-based crosslinking system, comprising a copper(II) carboxylate of formula: (RCOO)₂Cu,
      in which R represents a hydrocarbon-based group chosen from linear or branched, cyclic or non-cyclic alkyls having from 1 to 20 carbon atoms, aryls, aralkyls or alkaryls having from 1 to 20 carbon atoms.

Further subjects of the invention are a process for preparing a rubber composition according to the invention and the use of this composition for the manufacture of tires or of semi-finished products made of rubber intended for these tires.

The present invention relates to diene rubber compositions that can be used, in particular, for the manufacture of tires or of semi-finished products for tires such as treads.

The vulcanization of diene elastomers by sulphur is widely used in the rubber industry, in particular in the tire industry. In order to vulcanize diene elastomers, a relatively complex vulcanization system is used that comprises, in addition to sulphur, various vulcanization accelerators and also one or more vulcanization activators, very particularly derivatives of zinc such as zinc oxide (ZnO) alone or used with fatty acids.

Tire manufacturers seek solutions that make it possible to very greatly reduce or even, if possible, eliminate zinc or derivatives thereof from their rubber formulations, due to the known environmental impact of these compounds, especially with respect to water and aquatic organisms (classification N; R50/53: Very toxic to aquatic organisms, may cause long-term adverse effects in the aquatic environment).

It is found, however, that the reduction of the zinc oxide content, in particular in blends having a predominant content of natural rubber, such as those used in heavy vehicle tire treads, leads to numerous drawbacks:

a drop in the number of sulphur bridges during the vulcanization of the blends, which results in both a reduction of the moduli of the blends and an increase in the hysteresis, therefore an increase in the rolling resistance.

Of course, it would appear advantageous to eliminate or very greatly reduce the zinc by adapting the vulcanization system and, in particular, by increasing the sulphur content and also the content of other accelerators customarily used with zinc derivatives. However, a person skilled in the art knows that although increasing the sulphur and accelerator contents actually makes it possible to achieve a targeted bridge density, on the other hand this is at the expense of the compromise between the distribution of the sulphur network, that is to say the percentages of sulphur bridges formed with one sulphur atom, two sulphur atoms, more than two sulphur atoms, and the properties directly linked to the crosslinking such as the scorch time, the optimum curing time, etc. And this is even more pronounced for elastomeric matrices predominantly based on natural rubber or on synthetic isoprene.

In order to respond to the problem of zinc elimination, it has therefore also been proposed in document WO 2003/054081 to replace zinc oxide with another metal oxide, or else with a salt or oxide of a transition metal belonging to groups IIIA, IVA, VA, VIA, VIIA or VIIIA from the Periodic Table of the Elements, particularly cobalt or nickel. It should be noted that nickel does not constitute a viable solution for the future due to its toxicity to human health.

Furthermore, many metal oxides or salts among the columns of transition metals presented above do not fulfil their role of activator when the predominant elastomer of the rubber composition is an isoprene elastomer.

However, the Applicant has found a novel solution which makes it possible to very to significantly reduce the zinc content in rubber formulations, while protecting the rubber compositions from all of the aforementioned drawbacks. And, in particular, this novel solution makes it possible to carry out an activation of the vulcanization even in a composition that contains predominantly an isoprene elastomer.

A first subject of the invention therefore relates to a rubber composition that can be used, in particular, for the manufacture of tires, said rubber composition is based on at least one diene elastomer, containing less than 0.5 phe of zinc, phe signifying parts per hundred parts of elastomer, and based on at least:
one reinforcing filler;
one sulphur-based crosslinking system,
a copper(II) carboxylate of formula: (RCOO)₂Cu,
   in which R represents a hydrocarbon-based group chosen from linear or branched, cyclic or non-cyclic alkyls having from 1 to 20 carbon atoms, aryls, aralkyls or alkaryls having from 1 to 20 carbon atoms.

One subject of the invention is very particularly the use of a rubber composition according to the invention for the manufacture of tires or of semi-finished products made of rubber intended for these tires, these semi-finished products being especially chosen from the group constituted by treads, underlayers intended, for example, to be placed under these treads, crown plies, sidewalls, carcass plies, beads, protectors, inner tubes and airtight inner liners for tubeless tires.

Advantageously, the invention relates to a zinc-free rubber composition.

Preferably, in the copper carboxylate of formula: (RCOO)₂Cu, R represents a hydrocarbon-based group having from 1 to 13 carbon atoms, and preferably the copper carboxylate is copper(II) acetate, copper(II) 2-ethylhexanoate, copper(II) nonanoate or copper(II) laurate.

According to one favoured embodiment of the invention, the diene elastomer comprises more than 40 phe of isoprene elastomer, preferably more than 50 phe of isoprene elastomer and in particular it comprises 100 phe of isoprene elastomer.

Advantageously, the reinforcing filler comprises carbon black at a content greater than 10 phe, preferably the reinforcing filler predominantly comprises carbon black.

According to another embodiment of the invention, the reinforcing filler comprises a blend of carbon black and of an inorganic filler, in particular the inorganic filler comprises silica and more particularly the reinforcing filler comprises silica and carbon black, the amount of silica being less than or equal (by weight) to the amount of carbon black.

The invention also relates to the process for preparing a rubber composition based on at least one diene elastomer, containing less than 0.5 phe of zinc, characterized in that incorporated into the diene elastomer via kneading is at least one reinforcing filler, and one sulphur-based crosslinking system comprising a copper(II) carboxylate of formula (RCOO)₂Cu, in which:

R represents a hydrocarbon-based group chosen from linear or branched, cyclic or non-cyclic alkyls having from 1 to 20 carbon atoms, aryls, aralkyls or alkaryls having from 1 to 20 carbon atoms.

Advantageously, the diene elastomer comprises more than 40 phe of isoprene elastomer, preferably more than 50 phe of isoprene elastomer and in particular it comprises 100 phe of isoprene elastomer.

The composition according to the invention is particularly suitable for the manufacture of tire treads intended to equip “heavy-duty” vehicles (that is to say underground, bus, heavy road transport vehicles (lorries, tractors, trailers) or off-road vehicles), aircraft, earthmoving equipment, heavy agricultural vehicles or handling vehicles.

Another subject of the invention is these ground-contact systems of motor vehicles, these tires and semi-finished products made of rubber themselves, especially treads, when they comprise a rubber composition according to the invention. One subject of the invention is, in particular, the use of such treads for the manufacture of new tires or the retreading of used tires.

The invention also relates to these ground-contact systems of motor vehicles, tires and treads both in the green state (i.e. before curing) and in the cured state (i.e. after crosslinking or vulcanization).

The invention and also its advantages will be easily understood in light of the detailed description and exemplary embodiments that follows.

### DETAILED DESCRIPTION OF THE INVENTION

The compositions of the invention are based: (i) on at least one diene elastomer, (ii) on at least one reinforcing filler, and on a sulphur-based vulcanization system comprising at least (iii) one copper carboxylate of formula (RCOO)₂Cu.

The expression “composition based on” should be understood, in the present application, to mean a composition comprising the reaction product and/or mixture of the various constituents used, some of these base constituents (for example the coupling agent and the inorganic filler) being capable of reacting or intended to react with one another, at least in part, during the various phases of manufacture of the compositions, in particular during their vulcanization (curing).

In the present description, unless expressly indicated otherwise, all the percentages (%) indicated are % by weight.

### Diene Elastomer

An elastomer or rubber (the two terms being synonymous) of “diene” type is understood to mean, generally, an elastomer derived at least in part (i.e., a homopolymer or a copolymer) from diene monomers (monomers bearing two carbon-carbon double bonds which may or may not be conjugated).

Diene elastomers may be classified, in a known manner, into two categories: those said to be “essentially unsaturated” and those said to be “essentially saturated”. The expression “essentially unsaturated diene elastomer” is understood to mean a diene elastomer resulting at least partly from conjugated diene monomers, having a content of units of diene origin (conjugated dienes) that is greater than 15% (mol %). Thus, for example, diene elastomers such as butyl rubbers or diene/α-olefin copolymers of the EPDM type do not fall under this definition and may be described, on the contrary, as “essentially saturated diene elastomers” (low or very low content of units of diene origin, always less than 15%). Within the “essentially unsaturated” diene elastomer category, the expression “highly unsaturated diene elastomer” is understood in particular to mean a diene elastomer having a content of units of diene origin (conjugated dienes) that is greater than 50%.

Having given these definitions, it will be understood more particularly that a diene elastomer that can be used in the compositions according to the invention means:

(a)—any homopolymer obtained by polymerizing a conjugated diene monomer having 4 to 12 carbon atoms;
(b)—any copolymer obtained by copolymerizing one or more conjugated dienes with one another or with one or more vinylaromatic compounds having 8 to 20 carbon atoms;
(c)—a ternary copolymer obtained by copolymerizing ethylene, an α-olefin having 3 to 6 carbon atoms with an unconjugated diene monomer having 6 to 12 carbon atoms, such as for example the elastomers obtained from ethylene, propylene and an unconjugated diene monomer of the aforementioned type such as in particular 1,4-hexadiene, ethylidene norbornene and dicyclopentadiene; and
(d)—a copolymer of isobutene and isoprene (butyl rubber), and also the halogenated, in particular chlorinated or brominated, versions of this type of copolymer.

Although the present invention applies to any type of diene elastomer, a person skilled in the art of tires will understand that it is preferably used with essentially unsaturated diene elastomers, in particular of the (a) or (b) type above.

Suitable conjugated dienes are, in particular, 1,3-butadiene, 2-methyl-1,3-butadiene, 2,3-di(C₁-C₅)alkyl-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. Suitable vinylaromatic compounds are, for example, styrene, ortho-, meta- and para-methylstyrene, the commercial “vinyl-toluene” mixture, para-(tert-butyl)styrene, methoxystyrenes, chlorostyrenes, vinylmesitylene, divinylbenzene and vinylnaphthalene.

The copolymers can comprise between 99% and 20% by weight of diene units and between 1% and 80% by weight of vinylaromatic units. The elastomers can have any microstructure which depends on the polymerization conditions used, in particular on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or else functionalized with a coupling and/or star-branching or functionalizing agent.

For coupling with carbon black, mention may be made, for example, of functional groups comprising a C—Sn bond or of aminated functional groups, such as benzophenone, for example; for coupling with a reinforcing inorganic filler such as silica, mention may be made, for example, of silanol functional groups or polysiloxane functional groups having a silanol end (as described, for example, in FR 2 740 778 or U.S. Pat. No. 6,013,718), of alkoxysilane groups (as described, for example, in FR 2 765 882 or U.S. Pat. No. 5,977,238), of carboxyl groups (as described, for example, in WO 01/92402 or U.S. Pat. No. 6,815,473, WO 2004/096865 or US 2006/0089445) or else of polyether groups (as described, for example, in EP 1 127 909 or U.S. Pat. No. 6,503,973). Mention may also be made, as other examples of functionalized elastomers, of the elastomers (such as SBR, BR, NR or IR) of the epoxidized type.

Polybutadienes are suitable and in particular those having a content (molar %) of 1,2-units of between 4% and 80% or those having a content (molar %) of cis-1,4-units of greater than 80%, polyisoprenes, butadiene/styrene copolymers and in particular those having a T_{g} (glass transition temperature, T_{g}, measured according to ASTM D3418) of between 0° C. and −70° C. and more particularly between −10° C. and −60° C., a styrene content of between 5% and 60% by weight and more particularly between 20% and 50%, a content (molar %) of 1,2-bonds of the butadiene part of between 4% and 75% and a content (molar %) of trans-1,4-bonds of between 10% and 80%, butadiene/isoprene copolymers and in particular those having an isoprene content of between 5% and 90% by weight and a T_{g} of −40° C. to −80° C., or isoprene/styrene copolymers and in particular those having a styrene content of between 5% and 50% by weight and a T_{g} of between −25° C. and −50° C. In the case of butadiene/styrene/isoprene copolymers, those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content (molar %) of 1,2-units of the butadiene part of between 4% and 85%, a content (molar %) of trans-1,4-units of the butadiene part of between 6% and 80%, a content (molar %) of 1,2- plus 3,4-units of the isoprene part of between 5% and 70% and a content (molar %) of trans-1,4-units of the isoprene part of between 10% and 50%, and more generally any butadiene/styrene/isoprene copolymer having a T_{g} of between −20° C. and −70° C., are suitable in particular.

To sum up, the diene elastomer of the composition in accordance with the invention is particularly preferably chosen from the group of (highly unsaturated) diene elastomers formed by polybutadienes (BR), synthetic polyisoprenes (IR), natural rubber (NR), butadiene copolymers, isoprene copolymers and mixtures of these elastomers. Such copolymers are more preferably chosen from the group formed by butadiene/styrene copolymers (SBR), isoprene/butadiene copolymers (BIR), isoprene/styrene copolymers (SIR), isoprene/butadiene/styrene copolymers (SBIR) and blends of such copolymers.

According to one specific embodiment, the diene elastomer is predominantly (i.e., for more than 50 phe) an SBR, whether it is an SBR prepared in emulsion (“ESBR”) or an SBR prepared in solution (“SSBR”), or an SBR/BR, SBR/NR (or SBR/IR), BR/NR (or BR/IR) or else SBR/BR/NR (or SBR/BR/IR) blend (mixture). In the case of an SBR (ESBR or SSBR) elastomer, use is made in particular of an SBR having a moderate styrene content, for example of between 20% and 35% by weight, or a high styrene content, for example from 35 to 45%, a content of vinyl bonds of the butadiene part of between 15% and 70%, a content (molar %) of trans-1,4-bonds of between 15% and 75% and a T_{g} of between −10° C. and −55° C.; such an SBR can advantageously be used as a mixture with a BR preferably having more than 90% (molar %) of cis-1,4-bonds.

The composition according to the invention is in particular intended, preferably, for a heavy-duty vehicle tire tread, the diene elastomer is preferably an isoprene elastomer, that is to say an isoprene homopolymer or copolymer, in other words a diene elastomer chosen from the group formed by natural rubber (NR), synthetic polyisoprenes (IR), various isoprene copolymers or a blend of these elastomers. Mention will in particular be made, among isoprene copolymers, of isobutene/isoprene (butyl rubber/IIR), isoprene/styrene (SIR), isoprene/butadiene (BIR) or isoprene/butadiene/styrene (SBIR) copolymers. This isoprene elastomer is preferably natural rubber or a synthetic cis-1,4-polyisoprene; use is preferably made, among these synthetic polyisoprenes, of the polyisoprenes having a content (molar %) of cis-1,4-bonds of greater than 90%, more preferably still of greater than 98%. For such a tire for a heavy-duty vehicle, the diene elastomer may also be constituted, completely or partly, of another highly unsaturated elastomer such as, for example, an SBR elastomer.

In particular, it is advantageous for the diene elastomer to contain at least 40 phe of isoprene elastomer.

In the case of a passenger vehicle tire. In such a case, the diene elastomer is preferably an SBR copolymer, in particular an SBR prepared in solution, preferably used as a blend with a polybutadiene. More preferably, the SBR has a styrene content of between 20% and 30% by weight, a content of vinyl bonds of the butadiene part of between 15% and 65%, a content of trans-1,4-bonds of between 15% and 75% and a T_{g} of between −20° C. and −55° C., and the polybutadiene has more than 90% of cis-1,4-bonds.

The compositions of the treads of the invention can comprise a single diene elastomer or a mixture of several diene elastomers, it being possible for the diene elastomer or elastomers to be used in combination with any type of synthetic elastomer other than a diene elastomer, or even with polymers other than elastomers, for example thermoplastic polymers.

### Reinforcing Filler

Use is preferably made, as reinforcing filler, of carbon black in a proportion of greater than 10 phe. The amount of carbon black may advantageously be greater than 30 phe, especially when it constitutes the only reinforcing filler or the predominant reinforcing filler.

However, carbon black may of course be used as a blend with reinforcing fillers and in particular inorganic fillers. Such inorganic fillers include silica, preferably the latter, in a tire application intended for heavy-duty vehicles, will remain in a proportion less than or equal, by weight, to the amount of carbon black.

More particularly, all carbon blacks, in particular blacks of the HAF, ISAF or SAF type, conventionally used in tires and particularly the treads of tires, are suitable as carbon blacks. Mention may be made, as non-limiting examples of such blacks, of the N115, N134, N234, N330, N339, N347 or N375 blacks, or else, depending on the applications targeted, the blacks of higher series (for example, N660, N683 or N772). The carbon blacks might, for example, be already incorporated into the isoprene elastomer in the form of a masterbatch (see, for example, Applications WO 97/36724 or WO 99/16600).

Mention may be made, as examples of organic fillers other than carbon blacks, of the functionalized polyvinylaromatic organic fillers as described in Applications WO-A-2006/069792 and WO-A-2006/069793.

The expression “reinforcing inorganic filler” should be understood, in the present application, by definition, as meaning any inorganic or mineral filler, whatever its colour and its origin (natural or synthetic), also known as “white filler”, “clear filler” or even “non-black filler”, in contrast to carbon black, capable of reinforcing by itself alone, without means other than an intermediate coupling agent, a rubber composition intended for the manufacture of tires, in other words capable of replacing, in its reinforcing role, a conventional tire-grade carbon black; such a filler is generally characterized, in a known way, by the presence of hydroxyl (—OH) groups at its surface.

The physical state in which the reinforcing inorganic filler is present is not important, whether it is in the form of a powder, of microbeads, of granules, of beads or any other appropriate densified form. Of course, the expression “reinforcing inorganic filler” is also understood to mean mixtures of various reinforcing inorganic fillers, in particular of highly dispersible siliceous and/or aluminous fillers as described below.

In the case of the use of a silica, a highly dispersible precipitated silica is preferably used, in particular when the invention is employed for the manufacture of tires exhibiting a low rolling resistance; mention may be made, as non-limiting examples of such preferred highly dispersible silicas, of the Ultrasil 7000 and Ultrasil 7005 silicas from Degussa, the Zeosil 1165 MP, 1135 MP and 1115 MP silicas from Rhodia, the Hi-Sil EZ150G silica from PPG, the Zeopol 8715, 8745 and 8755 silicas from Huber or treated precipitated silicas such as, for example, the silicas “doped” with aluminium described in the abovementioned Application EP-A-0 735 088.

The reinforcing alumina (Al₂O₃) used is preferably a highly dispersible alumina having a BET surface area ranging from 30 to 400 m²/g, more preferably between 60 and 250 m²/g, and a mean particle size at most equal to 500 nm, more preferably at most equal to 200 nm. Mention may in particular be made, as non-limiting examples of such reinforcing aluminas, of the “Baikalox A125” or “CR125” (Baïkowski), “APA-100RDX” (Condea), “Aluminoxid C” (Degussa) or “AKP-G015” (Sumitomo Chemicals) aluminas.

Mention may also be made, as other examples of inorganic filler capable of being used in the rubber compositions of the invention, of aluminium (oxide) hydroxides, aluminosilicates, titanium oxides, silicon carbides or nitrides, all of the reinforcing type as described in documents WO 99/28376 (or U.S. Pat. No. 6,610,261), WO 00/73372 (or U.S. Pat. No. 6,747,087), WO 02/053634 (or US 2004/0030017), WO 2004/003067 and WO 2004/056915.

Finally, a person skilled in the art will understand that a reinforcing filler of another nature, in particular an organic filler, could be used as a filler equivalent to the reinforcing inorganic filler described in the present section, provided that this reinforcing filler is covered with an inorganic layer, such as silica, or else comprises, at its surface, functional sites, in particular hydroxyl sites, requiring the use of a coupling agent in order to establish the bonding between the filler and the elastomer.

It is recalled here that the expression “coupling agent” is understood, in a known manner, to mean an agent capable of establishing a sufficient bond, of chemical and/or physical nature, between the inorganic filler and the diene elastomer; such a coupling agent, which is at least bifunctional, has, for example, a simplified general formula “Y-A-X”, in which:
Y represents a functional group (“Y” functional group) which is capable of bonding physically and/or chemically to the inorganic filler, such a bond possibly being established, for example, between a silicon atom of the coupling agent and the surface hydroxyl (OH) groups of the inorganic filler (for example, the surface silanols when it is silica);
X represents a functional group (“X” functional group) capable of bonding physically and/or chemically to the diene elastomer, for example via a sulphur atom; and
A represents a divalent group allowing Y to be linked to X.

Coupling agents, especially silica/diene elastomer coupling agents, have been described in a very large number of documents, the most well-known being bifunctional organosilanes bearing alkoxy functional groups (that is to say, by definition, “alkoxysilanes”) as “Y” functional groups and, as “X” functional groups, functional groups capable of reacting with the diene elastomer, such as for example polysulphide functional groups.

It is also possible to add to the reinforcing filler (i.e. reinforcing inorganic filler plus carbon black, where appropriate), depending on the targeted application, inert (non-reinforcing) fillers such as particles of clay, bentonite, talc, chalk or kaolin, that can be used, for example, in coloured tire treads or sidewalls.

### Various Additives

The rubber compositions according to the invention may also comprise all or some of the standard additives conventionally used in elastomer compositions intended for the manufacture of tires, such as for example plasticizers or extender oils, whether the latter are of aromatic or non-aromatic nature, pigments, protective agents, such as anti-ozone waxes, chemical antiozonants, antioxidants, anti-fatigue agents, reinforcing resins, methylene acceptors (for example, phenol-novolac resin) or methylene donors (for example, HMT or H3M) as described, for example, in application WO 02/10269 (or US2003-0212185).

In particular, in applications such as tire sidewalls, a person skilled in the art may make use of plasticizers or extender oils while generally remaining in amounts of less than or equal to 30 phe.

### Vulcanization or Crosslinking System

The compositions also comprise a crosslinking system based either on sulphur or on sulphur and/or peroxide and/or bismaleimide donors, vulcanization accelerators and vulcanization activators. Of course, if an activator or an accelerator is based on zinc, the sum of the zinc elements included in total in the composition must respect a total zinc content of less than 0.5 phe, in accordance with the invention.

The actual vulcanization system is preferably based on sulphur and on a primary vulcanization accelerator, in particular an accelerator of sulphenamide type, such as chosen from the group constituted by 2-mercaptobenzothiazyl disulphide (abbreviated to “MBTS”), N-cyclohexyl-2-benzothiazyl sulphenamide (abbreviated to “CBS”), N,N-dicyclohexyl-2-benzothiazyl sulphenamide (abbreviated to “DCBS”), N-tert-butyl-2-benzothiazyl sulphenamide (abbreviated to “TBBS”), N-tert-butyl-2-benzothiazyl sulphenimide (abbreviated to “TBSI”) and mixtures of these compounds.

The sulphur is used at a content preferably between 0.5 and 10 phe, more preferably between 0.5 and 5.0 phe, for example between 0.5 and 3.0 phe when the invention is applied to a tire tread.

The compositions according to the invention may comprise zinc oxides in a very low amount in order to limit the amount of zinc present in the composition, preferably in amounts of less than 0.5. And advantageously, the composition is free of zinc oxide, the vulcanization activator being replaced by a copper carboxylate.

The copper(II) carboxylates according to the invention are copper carboxylates of formula (RCOO)₂Cu, in which R represents a hydrocarbon-based group chosen from linear or branched, cyclic or non-cyclic alkyls having from 1 to 20 carbon atoms, aryls, aralkyls or alkaryls having from 1 to 20 carbon atoms.

The corresponding carboxylates for which the R radical has between 1 and 13 carbon atoms, such as copper(II) acetate, corresponding to R with 1 carbon atom, copper(II) 2-ethylhexanoate, R has 7 carbon atoms, copper(II) nonanoate where R has 8 carbon atoms and copper(II) laurate, R has 11 carbon atoms will preferably be noted.

### Manufacture of the Rubber Compositions

The invention also relates to a process for preparing a rubber composition based on diene elastomer, containing less than 0.5 phe of zinc, characterized in that incorporated into at least one diene elastomer via kneading is at least one reinforcing filler, and at least one sulphur-based crosslinking system comprising a copper(II) carboxylate of formula (RCOO)₂Cu, in which:

R represents a hydrocarbon-based group chosen from linear or branched, cyclic or non-cyclic alkyls having from 1 to 20 carbon atoms, aryls, aralkyls or alkaryls having from 1 to 20 carbon atoms.

The rubber compositions according to the invention are manufactured in appropriate mixers, using two successive preparation stages according to a general procedure well known to those skilled in the art: a first thermomechanical working or kneading stage (sometimes described as a “non-productive” stage) at high temperature, up to a maximum temperature between 130° C. and 200° C., preferably between 145° C. and 185° C., followed by a second mechanical working stage (sometimes described as a “productive” stage) at lower temperature, typically below 120° C., for example between 60° C. and 100° C., during which finishing stage the crosslinking or vulcanization system is incorporated.

According to one preferred embodiment of the invention, all the base constituents of the compositions of the invention, with the exception of the vulcanization system, namely carbon black, an optional other reinforcing filler and an optional coupling agent, are intimately incorporated, by kneading, into the diene elastomer during the so-called non-productive first stage, that is to say these various base constituents are introduced into the mixer and thermomechanically kneaded, in one or more steps, until the maximum temperature between 130° C. and 200° C., preferably between 145° C. and 185° C., is reached.

By way of example, the first (non-productive) stage is carried out in a single thermomechanical step during which all the necessary constituents, the optional complementary covering agents or processing aids and other various additives, with the exception of the vulcanization system, are introduced into a suitable mixer, such as a standard internal mixer. The total kneading time in this non-productive stage is preferably between 1 and 15 min. After cooling the mixture obtained in this way during the non-productive first stage, the vulcanization system is then incorporated at low temperature, generally in an external mixer such as an open mill. All the ingredients are then mixed (productive stage) for a few minutes, for example between 2 and 15 min.

The vulcanization system proper is preferably based on sulphur and on a primary accelerator, preferably of sulphonamide type as previously described in detail in the vulcanization system.

Various known secondary accelerators or vulcanization activators are added to this vulcanization system, these being incorporated during the non-productive first stage and/or during the productive stage, including one or more copper(II) carboxylates of formula (RCOO)₂Cu according to the invention, or even other zinc derivatives as long as the latter remain in the minority and below the amounts specified in the section on the vulcanization system, and optionally fatty acids such as stearic acid, guanidine derivatives (in particular, diphenylguanidine), etc.

The final composition thus obtained is then calendered, for example in the form of a film or a sheet, especially for laboratory characterization, or else extruded in the form of a rubber profiled element that can be used for example as a tire tread for a passenger vehicle.

The vulcanization (or curing) is carried out in a known manner at a temperature generally between 130° C. and 200° C., for a sufficient time, which may for example vary between 5 and 90 minutes, depending in particular on the curing temperature, on the vulcanization system adopted and on the vulcanization kinetics of the composition in question.

In summary, the process for preparing a rubber composition based on diene elastomer, containing less than 2 phe of zinc, and comprising at least one reinforcing filler, and at least one sulphur-based crosslinking system comprising a copper carboxylate of formula (RCOO)₂Cu, in which:

R represents a hydrocarbon-based group chosen from linear or branched, cyclic or non-cyclic alkyls having from 1 to 20 carbon atoms, aryls, aralkyls or alkaryls having from 1 to 20 carbon atoms,
comprises the following steps:
incorporating into the diene elastomer, in a mixer, the reinforcing filler and the copper(II) carboxylate of formula (RCOO)₂Cu by thermomechanically kneading all the ingredients, one or more times, until a maximum temperature between 130° C. and 200° C. is reached;
cooling the mixture down to a temperature below 100° C.;
then incorporating: the vulcanization system, except for the already incorporated carboxylate, this vulcanization system being such that the zinc content in the final composition is less than 0.5 phe;
kneading everything up to a maximum temperature below 120° C.; and
extruding or calendering the rubber composition thus obtained.

### EXEMPLARY EMBODIMENTS OF THE INVENTION

### Measurements and Tests Used

The rubber compositions are characterized, before and after curing, as indicated below.

### Rheometry

The measurements are carried out at 150° C. with an oscillating disc rheometer, according to standard DIN 53529—part 3 (June 1983). The change in the rheometric torque, ΔTorque, as a function of time describes the change in the stiffening of the composition as a result of the vulcanization reaction. The measurements are processed according to standard DIN 53529—part 2 (March 1983): T₀ is the induction time, that is to say the time necessary for the start of the vulcanization reaction; T_{α} (for example T₉₅) is the time necessary to achieve a conversion of α %, that is to say α % (for example 95%) of the difference between the minimum and maximum torques. The conversion rate constant denoted by K (expressed in min⁻¹), which is 1st order, calculated between 30% and 80% conversion, which makes it possible to assess the vulcanization kinetics, is also measured.

### Preparation of the Compositions

The various compositions presented in the following tests are prepared in an identical manner as follows:

introduced successively into an internal mixer, which is 70% filled and for which the initial chamber temperature is around 60° C., are the reinforcing filler (carbon black, other optional possible fillers and optionally coupling agent), the diene elastomer and also the various other ingredients including the secondary vulcanization accelerator with the exception of the rest of the vulcanization system. Thermomechanical work (non-productive stage) is then carried out in one step, which lasts in total around 3 to 4 minutes, until a maximum “dropping” temperature of 165° C. is reached. The mixture thus obtained is recovered, cooled, then the rest of the vulcanization system (sulphur, primary sulphenamide-type accelerator) is incorporated in an external mixer (homofinisher) at 30° C., mixing everything (productive stage) for a suitable time (for example, between 5 and 12 min).

### Example

In this example, for various elastomeric matrices and reinforcing fillers, three control compositions are compared with several compositions from the prior art and several compositions according to the invention, these various compositions being distinguished only by their vulcanization system, and more particularly by the vulcanization activator. In particular, the rheometric properties of these compositions are compared.

All these compositions are intended for the manufacture of a tread of a tire for a heavy-duty motor vehicle.

The first “conventional” control composition is a composition having a vulcanization system containing zinc oxide whilst in the second control composition there is no vulcanization activator or accelerator and the third contains a copper(II) oxide in place of the zinc oxide.

The compositions corresponding to the prior art contain other metal oxides or salts as a replacement for the zinc oxide whilst the compositions according to the invention contain copper(II) carboxylates in place of the zinc oxide or other metal oxides or salts of the compositions of the prior art.

The content of metal oxides or salts in each of the compositions was calculated so as to be isomolar in metal cations (for example copper H for the compositions according to the invention) relative to one of the control compositions that includes 3 phe of ZnO (i.e. 2.4 phe of zinc), content conventionally used for compositions intended for the aforementioned manufacture.

All the compositions have the same base formulation below expressed as parts per hundred parts of elastomer by weight, phe:

| | |
|---|---|
| Elastomer NR (1) | 100 |
| Carbon black N220 | 47.5 |
| Sulphur/ | 1.5 |
| CBS (2) | 0.6 |

(1) NR: natural rubber (peptized)
(2) Accelerator: N-cyclohexyl-2-benzothiazyl sulphenamide (CBS)

Thus, the following notations will be used: T1, T2 and T3 for the control compositions; A1, A2 and A3 for the compositions of the prior art and C1, C2, C3 and C4 for the compositions according to the invention. These compositions respectively use the following vulcanization activators in the following amounts:
for T1: zinc oxide, ZnO, with stearic acid,
for T2: no activator;
for T3: copper(II) oxide;
for A1: iron oxide;
for A2: zirconium dioxide;
for A3: zirconium 2-ethylhexanoate;
for C1: copper(II) acetate;
for C2: copper(II) 2-ethylhexanoate;
for C3: copper(II) nonanoate, and
for C4: copper(II) laurate.

These compositions T1, T2, A1, A2 and A3 are therefore distinguished from one another as presented in Table 1 below, the amounts being indicated as phe.

TABLE 1

| Compositions | T1 | T2 | T3 | A1 | A2 | A3 | C1 | C2 | C3 | C4 |
|---|---|---|---|---|---|---|---|---|---|---|
| ZnO/stearic acid | 3/2.5 | — | — | — | — | — | — | — | — | — |
| Copper(II) oxide | — | — | 2.9 | — | — | — | — | — | — | — |
| Iron(II) oxide | — | — | — | 2.6 | — | — | — | — | — | — |
| Zirconium dioxide | — | — | — | — | 4.5 | — | — | — | — | — |
| Zirconium | — | — | — | — | — | 24.3 | — | — | — | — |
| 2-ethylhexanoate | | | | | | | | | | |
| Copper(II) acetate | — | — | — | — | — | — | 7.4 | — | — | — |
| Copper(II) | — | — | — | — | — | — | — | 12.9 | — | — |
| 2-ethylhexanoate | | | | | | | | | | |
| Copper(II) nonanoate | — | — | — | — | — | — | — | — | 13.9 | — |
| Copper(II) laurate | — | — | — | — | — | — | — | — | — | 17 |

The rheometric properties obtained for these various compositions are given in Table 2 below.

TABLE 2

| Compositions | T1 | T2 | T3 | A1 | A2 | A3 | C1 | C2 | C3 | C4 |
|---|---|---|---|---|---|---|---|---|---|---|
| ΔTorque (dN · m) | 6.6 | 2.9 | 3 | 2.9 | 2.9 | 1.6 | 5.3 | 5.5 | 5.3 | 4.8 |
| T₀ (min) | 3.7 | 0.0 | 2.1 | 0.0 | 0.0 | 0.0 | 1.0 | 1.1 | 1.2 | 1.2 |
| T₉₅ (min) | 15.6 | 31.5 | 7.3 | 35.8 | 42.6 | 37.0 | 11.4 | 17.6 | 16.4 | 17.8 |
| K (min⁻¹) | 0.25 | 0.10 | 0.58 | 0.08 | 0.07 | 0.08 | 0.29 | 0.18 | 0.20 | 0.18 |

In view of the results given in Table 2, it is easily observed that the compositions A1, A2 and A3 corresponding to the compositions from the prior art and based respectively on iron oxide, zirconium dioxide and zirconium 2-ethylhexanoate have comparable results to the control composition T2 that does not include any vulcanization activator. It is therefore clear that, for these compositions, the metal oxides or salts used do not make it possible to achieve an activation of the vulcanization (ΔTorque obtained demonstrating a very low crosslinking, high T₉₅ signifying a very slow reaction startup, with a very low constant K representative of very slow kinetics).

It is also observed that the composition T3 comprising copper oxide does not make it possible to activate the vulcanization either, as is clearly shown by the very low ΔTorque obtained that signifies a low crosslinking (the constant K indicating kinetics that are rapid but that only involve a few bonds).

It is observed that the various compositions according to the invention, C1 to C4, that include copper carboxylates make it possible to effectively activate the vulcanization (ΔTorque comparable to that of the composition T1 containing zinc oxide and much greater than the other control compositions and prior art compositions, which clearly shows an effective activation of the vulcanization, likewise for the kinetics constant K). This appears even more surprising after having observed that copper(II) oxide did not make it possible to activate the vulcanization, no more than did a zirconium carboxylate.

1) A rubber composition based on at least one diene elastomer, containing less than 0.5 phe of zinc, phe signifying parts per hundred parts of elastomer, and based on at least:
one reinforcing filler;
one sulphur-based crosslinking system, comprising a copper(II) carboxylate of formula: (RCOO)₂Cu,
in which R represents a hydrocarbon-based group chosen from linear or branched, cyclic or non-cyclic alkyls having from 1 to 20 carbon atoms, aryls, aralkyls or alkaryls having from 1 to 20 carbon atoms.

2) The composition according to claim 1, wherein R represents a hydrocarbon-based group having from 1 to 13 carbon atoms.

3) The composition according to claim 1, which is free of zinc.

4) The composition according to claim 1, wherein the copper carboxylate is copper acetate.

5) The composition according to claim 1, wherein the copper carboxylate is copper 2-ethylhexanoate.

6) The composition according to claim 1, wherein the copper carboxylate is copper nonanoate.

7) The composition according to claim 1, wherein the copper carboxylate is copper laurate.

8) The composition according to claim 1, wherein the diene elastomer comprises at least 40 phe of isoprene elastomer.

9) The composition according to claim 1, wherein the diene elastomer comprises at least 50 phe of isoprene elastomer.

10) The composition according to claim 1, wherein the diene elastomer comprises 100 phe of isoprene elastomer.

11) The composition according to claim 1, wherein the reinforcing filler comprises carbon black at a content greater than 10 phe.

12) The composition according to claim 11, wherein the reinforcing filler predominantly comprises carbon black.

13) The composition according to claim 11, wherein the reinforcing filler comprises a blend of carbon black and of an inorganic filler.

14) The composition according to claim 13, wherein the inorganic filler comprises silica.

15) The composition according to claim 14, wherein the reinforcing filler comprises silica and carbon black, the amount of silica being less than or equal (by weight) to the amount of carbon black.

16) A process for preparing a rubber composition based on at least one diene elastomer, containing less than 0.5 phe of zinc, wherein incorporated into the diene elastomer via kneading is at least one reinforcing filler, and one sulphur-based crosslinking system comprising a copper(II) carboxylate of formula (RCOO)₂Cu, in which:
R represents a hydrocarbon-based group chosen from linear or branched, cyclic or non-cyclic alkyls having from 1 to 20 carbon atoms, aryls, aralkyls or alkaryls having from 1 to 20 carbon atoms.

17) The process according to claim 16, comprising the steps of:
incorporating into the diene elastomer, in a mixer, the reinforcing filler and the copper carboxylate of formula (RCOO)₂Cu by thermomechanically kneading all the ingredients, one or more times, until a maximum temperature between 130° C. and 200° C. is reached;
cooling the mixture down to a temperature below 100° C.;
then incorporating: the vulcanization system except for the already incorporated carboxylate, this vulcanization system being such that the zinc content in the final composition is less than 0.5 phe;
kneading everything up to a maximum temperature below 120° C.; and
extruding or calendering the rubber composition thus obtained.

18) The process according to claim 16, wherein the zinc content of the final composition is equal to 0.

19) The process according to claim 16, wherein R represents a hydrocarbon-based group having from 1 to 13 carbon atoms.

20) The process according to claim 16, wherein the copper carboxylate is copper acetate.

21) The process according to claim 16, wherein the copper carboxylate is copper 2-ethylhexanoate.

22) The process according to claim 16, wherein the copper carboxylate is copper nonanoate.

23) The process according to claim 16, wherein the copper carboxylate is copper laurate.

24) The process according to claim 16, wherein the diene elastomer comprises at least 40 phe of isoprene elastomer.

25) The process according to claim 16, wherein the diene elastomer comprises at least 50 phe of isoprene elastomer.

26) The process according to claim 16, wherein the diene elastomer comprises 100 phe of isoprene elastomer.

27) The process according to claim 16, wherein the reinforcing filler comprises carbon black at a content greater than 10 phe.

28) The process according to claim 27, wherein the reinforcing filler comprises predominantly carbon black.

29) The process according to claim 27, wherein the reinforcing filler comprises a blend of carbon black and an inorganic filler.

30) The process according to claim 29, wherein the inorganic filler comprises silica.

31) The process according to claim 30, wherein the reinforcing filler comprises silica and carbon black, the amount of silica being less than or equal (by weight) to the amount of carbon black.

32) A tire comprising a rubber composition according to claim 1.

33) A semi-finished product being incorporated into tire manufacture comprising a rubber composition according to claim 1.

34) A tire tread comprising a rubber composition according to claim 1.
